(19) United States
(12) Patent Application Publication
(10) Pub. No.: US 2008/0316405 A1
(43) Pub. Date: Dec. 25, 2008

(54) DISPLAY SUBSTRATE AND LIQUID CRYSTAL DISPLAY DEVICE HAVING THE SAME

(76) Inventors: Min-Sik Jung, Seoul (KR); Soon-Joon Rho, Suwon-si (KR); Baek-Kyun Jeon, Yongin-si (KR); Hee-Keun Lee, Suwon-si (KR)

Correspondence Address: F. CHAU & ASSOCIATES, LLC, 130 WOODBURY ROAD, WOODBURY, NY, 11797, US

(21) Appl. No.: 12/141,711

(22) Filed: Jun. 18, 2008

(30) Foreign Application Priority Data
Jun. 21, 2007 (KR) 2007-61080

(51) Int. Cl. G02F 1/1337

(52) U.S. Cl. 349/123

(57) ABSTRACT

A display substrate includes an insulation substrate, a common electrode, a cell gap maintaining part, a liquid crystal (LC) alignment support part and an oxide alignment layer. The common electrode is formed on the insulation substrate. The cell gap maintaining part is formed on the common electrode. The LC alignment support part of an organic material is formed on the common electrode. The oxide alignment layer is formed on the LC alignment support part. Therefore, the alignment speed and response speed of liquid crystal molecules may be enhanced.

### CROSS-REFERENCE TO RELATED APPLICATIONS

This application claims priority under 35 U.S.C. § 119, of Korean Patent Application No. 2007-61080, filed on Jun. 21, 2007 in the Korean Intellectual Property Office (KIPO), which is herein incorporated by reference in its entirety.

### BACKGROUND OF THE INVENTION

1. Field of the Invention

The present invention relates to a display substrate and a liquid crystal display (“LCD”) device having the display substrate. More particularly, the present invention relates to a display substrate capable of enhancing an alignment speed and response speed of liquid crystal molecules, and an LCD device having the display substrate.

2. Description of the Related Art

Generally, a liquid crystal display (“LCD”) device includes an array substrate, a color filter substrate and a liquid crystal layer. The liquid crystal layer including a plurality of liquid crystal molecules is interposed between the array substrate and the color filter substrate. An alignment layer is disposed on each of the array substrate and the color filter substrate, which aligns the liquid crystal molecules included in the liquid crystal layer in a predetermined direction. The alignment layer is classified as either a horizontal alignment layer or a vertical alignment layer. The horizontal alignment layer aligns the liquid crystal molecules to be aligned in a horizontal direction with respect to the substrates while a voltage is not applied to the liquid crystal layer. In contrast, the vertical alignment layer allows the liquid crystal molecules of the liquid crystal layer to be inclined relative to major surfaces of the substrates while the voltage is not applied to the liquid crystal layer.

In conventional alignment layers, the horizontal alignment layer and the vertical alignment layer include a polyimide-containing material. The vertical alignment layer is primarily formed through processes such as printing the polyimide-containing material on a process substrate, and baking and curing the printed polyimide-containing material. In the processes, a solution is coated on a transfer surface and then a solvent component is volatilized, so that it is difficult to form the alignment layers to have a uniform thickness when the process substrate has a non-flat structure. For example, defects such as uncoated areas, vertical alignment errors of an alignment layer, etc. may be generated. The uncoated areas are generated at top portions of peaks or protrusions due to the viscosity of an alignment solution after a liquid film has been coated thereon. The vertical alignment errors are defects of which liquid crystal molecules are laid along two end portions of an inclined structure or an inclined portion.

### SUMMARY OF THE INVENTION

Exemplary embodiments of the present invention provides a display substrate capable of inducing uniform liquid crystal alignment when an inclined or a protruding structure is formed on a surface thereof so as to pretilt a liquid crystal layer.

The present invention also provides a liquid crystal display (LCD) device having the above-mentioned display substrate.

In one aspect of the present invention, a display substrate includes a common electrode, a cell gap maintaining part, a liquid crystal (LC) alignment support part and an oxide alignment layer. The common electrode is formed on the insulation layer. The cell gap maintaining part is formed on the common electrode. The LC alignment support part of an organic material is formed on the common electrode. The oxide alignment layer is formed on the LC alignment support part.

In an exemplary embodiment, the LC alignment support part has a plurality of inclined surfaces so as to pretilt a liquid crystal layer. Here, the LC alignment support part has a continuous mountain shape of which positively inclined surfaces and negatively inclined surfaces alternate.

In an exemplary embodiment, the display substrate may further include a color filter formed on the insulation substrate. The common electrode may be formed on a whole surface of the color filter.

In an exemplary embodiment, the LC alignment support part may have discontinuous protrusions so as to pretilt a liquid crystal layer.

In an exemplary embodiment, the oxide alignment layer may include at least one selected from the group consisting of silicon oxide (SiOx), titanium oxide (TiO2) and magnesium oxide (MgO).

In an exemplary embodiment, the LC alignment support part may be formed from the same material as that of the cell gap maintaining part.

In another aspect of the present invention, an LCD device includes a first substrate, a second substrate and a liquid crystal layer. The first substrate includes a pixel electrode formed on a first insulation substrate. The second substrate faces the first display substrate. The liquid crystal layer is interposed between the first display substrate and the second display substrate. The second display substrate includes a second insulation substrate, a common electrode, a cell gap maintaining part, a liquid crystal (LC) alignment support part and an oxide alignment layer. The common electrode is formed on the entire surface of the second insulation substrate. The cell gap maintaining part is formed on the common electrode. The LC alignment support part of an organic material is formed on the common electrode. The oxide alignment layer is formed on the LC alignment support part.

In an exemplary embodiment, the LC alignment support part may have a plurality of inclined surfaces so as to pretilt the liquid crystal layer.

In still another aspect of the present invention, an LCD device includes a first display substrate, a second display substrate, a liquid crystal layer, a cell gap maintaining part, a liquid crystal (LC) alignment support part and an oxide alignment layer. The first display substrate includes a first electrode formed on a first insulation substrate. The second display substrate faces the first display substrate. The second display substrate includes a second electrode formed on a second insulation substrate. The liquid crystal layer is formed between the first display substrate and the second display substrate. The cell gap maintaining part is positioned between the first display substrate and the second display substrate to maintain a predetermined distance between the first and second display substrates. The LC alignment support part is formed on the second electrode. The LC alignment support part has a plurality of inclined surfaces so at to pretilt the liquid crystal layer. The oxide alignment layer is formed on the LC alignment support part.

The alignment speed and response speed of liquid crystal molecules may be enhanced in the display substrate according to embodiments of the present invention and the LCD device having the display substrate manufactured. Furthermore, defects such as uncoated areas and vertical alignment errors of an alignment layer may be prevented.

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “on,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, variety of embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

### BRIEF DESCRIPTION OF THE DRAWINGS

The above and other features of the present invention will become readily apparent by reference to the following detailed description when considered in conjunction with the accompanying drawings in which:

FIG. 1 is a plan view of a multi-domain liquid crystal display (LCD) device according to an exemplary embodiment of the present invention;

FIG. 2 is a cross-sectional view taken along section line I-I′ of FIG. 1;

FIG. 3 is a cross-sectional view taken along section line II-II′ of FIG. 1; and

FIG. 4 is a cross-sectional view of a multi-domain LCD device according to another exemplary embodiment of the present invention.

### DETAILED DESCRIPTION OF EXEMPLARY EMBODIMENTS OF THE INVENTION

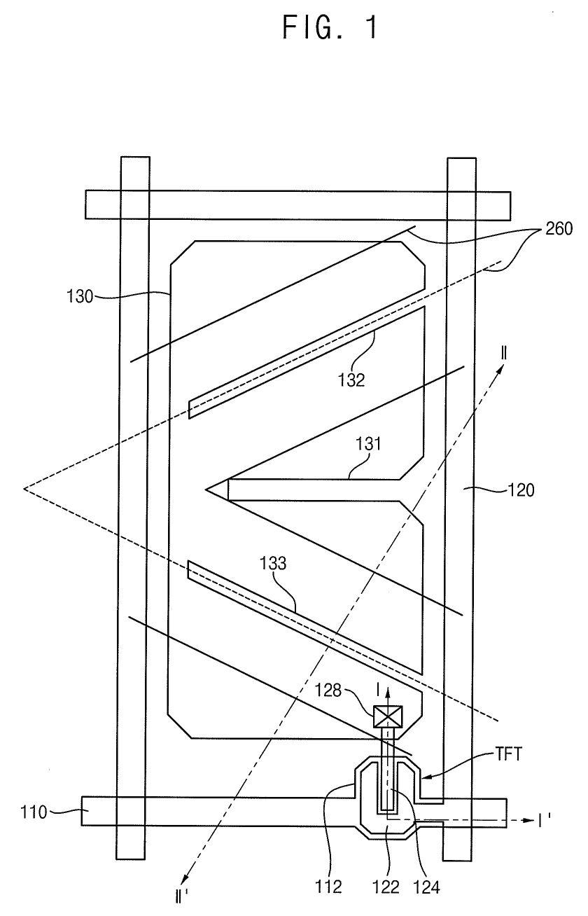

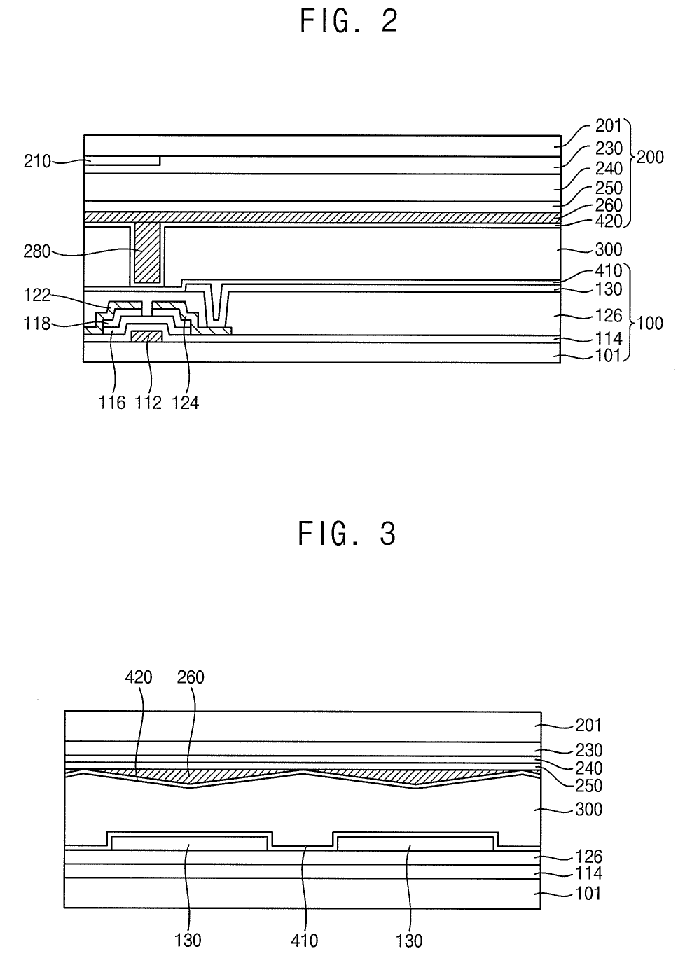

FIG. 1 is a plan view of a multi-domain liquid crystal display (“LCD”) device according to an exemplary embodiment of the present invention. FIG. 2 is a cross-sectional view taken along section line I-I′ of FIG. 1. FIG. 3 is a cross-sectional view taken along section line II-II′ of FIG. 1.

Referring to FIGS. 1 to 3, an LCD device according to an exemplary embodiment of the present invention includes a first display substrate 100, a second display substrate 200 and a liquid crystal layer 300 interposed between the first and second substrates 100 and 200.

The first display substrate 100 includes a first insulation substrate 101, a plurality of gate lines 110 that extends in a first direction on the first insulation substrate 101, a plurality of data lines 120 perpendicular to and crossing the gate lines 110, and a plurality of pixel electrodes 130. A charge developed on each pixel electrode 130 depends upon voltages on one of the gate lines 110 and one of the data lines 120. A pixel is formed at each intersection of gate lines 110 and the data lines 120, and includes a switch (e.g., a thin-film transistor, TFT) connected to a gate electrode 112 gate lines 110, a source (data) electrode 122 connected to one of the data lines. 120, and a drain electrode 124 connected to a pixel electrode 130. Each pixel electrode 130 is electrically connected to a drain electrode 124 through a contact hole 128.

The gate line 110 may be extended along the first direction (e.g., a horizontal direction when viewed in a plan view). A gate electrode 112 for each pixel protrudes from and is electrically connected to a gate line 110. A portion of each gate line 110 may be extended along the second direction (e.g., a vertical direction when viewed in a plan view) to define each gate electrode 112. A gate pad (not shown) is formed at an end portion of the gate line 110.

The data lines 120 may be extended along the second (vertical) direction. A portion of each data line 120 may be extended along the horizontal direction to define a source electrode 122. A data pad (not shown) is formed at an end portion of the data line 120. In an exemplary embodiment, the data line 120 may have a straight line shape. Alternatively, the data line 120 may have a plurality of bent portions. Here, a pixel electrode may be formed along each bent portion. The drain electrode 124 may be separated from the source electrode 122 by a predetermined (channel width) distance.

The gate line 110 may include, for example, a metallic conducting material such as chromium (Cr), aluminum (Al), tantalum (Ta), molybdenum (Mo), titanium (Ti), tungsten (W), copper (Cu), silver (Ag), etc., or a metal alloy thereof. The gate line 110 may have an at least two-layered structure of metallic materials having different physical characteristics from each other. For example, the gate line 110 may include a first metal layer, and a second metal layer that is sequentially formed on the first metal layer. The first metal layer includes at least one of aluminum (Al) and an aluminum (Al) alloy. The second metal layer includes at least one of molybdenum (Mo) and a molybdenum (Mo) alloy. Moreover, each of the data lines 120, the source electrodes 122 and the drain electrodes 124 may be formed of the metallic material or the metal alloy. Moreover, each of the data lines 120, the source electrodes 122 and the drain electrodes 124 may have the two-layered structure of the metallic materials.

A plurality of thin-film transistors (“TFTs”) is formed on the first display substrate 100, one TFT being formed in each pixel area, respectively. Each of the TFTs includes a gate electrode 112, a source electrode 122, a drain electrode 124, a gate insulation layer 114 and a semiconductor island formed in an active layer 116. The semiconductor (active) layer 116 may include an ohmic contact layer 118. The gate electrode 112 is electrically connected to one gate line 110. The source electrode 122 is electrically connected to one data line 120. The drain electrode 124 is electrically connected to a pixel electrode 130. The gate insulation layer 114 and the semiconductor (active) layer 116 are sequentially formed between the gate electrode 112 and the source and drain electrodes 122 and 124. The ohmic contact layer 118 may be formed in a portion of the active layer 116 over each semiconductor island. In an exemplary embodiment, the ohmic contact layer 118 may be formed on each semiconductor island in the active layer 116 except for a channel portion of each semiconductor island. The TFT controls the charge conducted to the pixel electrode 130 in response to a signal provided to the gate line 110 according to the pixel signal received via the data line 120.

An insulating protection (passivating) layer 126 is formed over the TFT. The insulating protection layer 126 may include an inorganic material such as silicon nitride (SiNx) and silicon oxide (SiOx), and a low-k organic material. Alternatively, the insulating protection layer 126 may have a two-layered structure of the inorganic material and organic layer.

The pixel electrode 130 and a common electrode on the second display substrate 200 generate an electric field between the first substrate 100 and the second display substrate 200. The pixel electrode 130 is formed on the insulating protection layer 126, and is electrically connected to the drain electrode 124 through a contact hole 128. The pixel electrode 130 may have a first patterned opening 131, a second patterned opening 132 and a third patterned opening 134 as a means for controlling the alignment direction of liquid crystal molecules. The first patterned opening 131 is formed in a position such that the pixel electrode 130 is divided into two in a horizontal direction, forming upper and lower portions of the divided pixel electrode 130. Each of the second and third patterned openings 132 and 133 is formed in upper and lower portions of the divided pixel electrode 130 in an inclined (diagonal) line direction, respectively. The first patterned opening 131 may be extended from the right edge portion of the pixel electrode 130 almost to the left edge portion of the pixel electrode 130. The right edge portion of the first patterned opening 131 may be enlarged (chamfered). The second and third patterned openings 132 and 133 may be formed along lines substantially perpendicular to each other, or at a more obtuse or a more acute angle. The first, second and third patterned openings 131, 132 and 133 may be formed in the divided pixel electrode 130 so as to uniformly disperse a direction of fringe field in four directions.

A first oxide alignment layer 410 is formed as the top layer on the first insulation substrate 101 having the pixel electrode 130 formed thereon. The first oxide alignment layer 410 aligns liquid crystal molecules of the liquid crystal layer 300 in a predetermined direction.

The display substrate 200 may include a black matrix 210 formed on a second insulation substrate 201, a color filter 230, an overcoat layer 240, a common electrode 250, a cell gap maintaining part (spacer) 280 and a shaped organic layer 260. In this exemplary embodiment, the shape organic layer 260 may perform a role of a liquid crystal (LC) support part.

The black matrix 210 is formed between a TFT area and pixel areas adjacent to the TFT area, so that the black matrix 210 may prevent light from one pixel area leaking into another adjacent pixel area and thus prevent light interference between adjacent pixel areas. Thus, the black matrix 210 may have an opening that exposes the pixel electrode 130 on the first display substrate 100.

The color filter 230 may have red color pixel filters R, green color pixel filters G and a blue color pixel filters B. The color filter 230 is formed to cover each opening of the black matrix 210 so as to transmit red light, green light and blue light. An overcoat layer 240 is formed on a rear surface of the color filter 230, which includes an organic material. Alternatively, the overcoat layer 240 may be omitted in accordance with the specifications of the LCD device.

The common electrode 250 is formed on the color filter 230, so that the common electrode 250 generates an electric field between the first display substrate 100 and the second display substrate 200. In this exemplary embodiment, the common electrode 250 is not patterned, and is formed over the entire surface of the color filter 230. Therefore, a patterning process of the common electrode 250 may be omitted.

The cell gap maintaining part (spacer) 280 is positioned between the first display substrate 100 and the second display substrate 200 to maintain a predetermined distance between the first display substrate 100 and the second display substrate 200. The cell gap spacer 280 may be formed on the common electrode 250 of the second substrate 200. The cell gap spacer 280 may be formed from the same organic material of the shaped organic layer 260. The cell gap spacer 280 may be formed on the black matrix 210 in order to prevent an aperture ratio from decreasing.

The shaped organic layer 260 has an alternately inclined surface for pretilting liquid crystal molecules of the liquid crystal layer 300 in order to assist in liquid crystal alignment. For example, the shaped organic layer 260 may have a continuous “mountain shaped” profile (as seen in cross-section FIG. 3) in which positively inclined surfaces and negatively inclined surfaces are adjacent and alternate. When the liquid crystal molecules are activated using a fringe field in a vertical alignment (“VA”) mode of the liquid crystal layer, the shaped organic layer 260 enhances the response speed of liquid crystal molecules by enhancing the rising time of the liquid crystal layer. An organic material is coated onto the common electrode 250, and then the organic material is patterned to form the shaped organic layer 260. Here, in order to control a random flow phenomenon that is generated when the voltage is applied during the VA mode of the liquid crystal layer 300, the shaped organic layer 260 pretilts the liquid crystal molecules of the liquid crystal layer 300 within each pixel domain area, so that the direction (orientation) of the liquid crystal molecules may be uniformly controlled over the entire area of the LCD device. In FIG. 1, two solid line segments denote the top (peak) of the shaped organic layer 260, and a dotted line segment denotes a bottom (valley) of the “mountain” shaped organic layer 260.

A second oxide alignment layer 420 is formed on the common electrode 250 on the shaped organic layer 260, and conformally covers the shaped organic layer 260 and the common electrode 250. The alignment of liquid crystal molecules may be controlled through the second oxide alignment layer 420 formed on the common electrode 250 and the mountain-shaped organic layer 260.

The first and second oxide alignment layers 410 and 420 may be manufactured by using, for example, chemical vapor deposition (“CVD”) such as plasma-enhanced CVD (“PECVD”), physical vapor deposition such as a sputtering process, etc. Alternatively, the first and second oxide alignment layers 410 and 420 may be manufactured by using, for example, an evaporation process.

The first and second oxide alignment layers 410 and 420 may include, for example, an inorganic material such as silicon oxide (SiOx), magnesium oxide (MgO), titanium oxide (TiO2), etc. When the first and second oxide alignment layers 410 and 420 include the silicon oxide (SiOx), the LCD device may have superior light stability.

The first and second oxide alignment layers 410 and 420 according to an exemplary embodiment of the present invention have a predetermined level of roughness due to unevenness of a formed surface thereof. When the first and second oxide alignment layers 410 and 420 are employed in a VA-mode LCD device, the first and second oxide alignment layers 410 and 420 control pretilt angles of liquid crystal molecules to be about 80 degrees to about 90 degrees.

Dielectric constants of the first and second oxide alignment layers 410 and 420 vary according to deposition method and deposition conditions, so that alignment characteristics of liquid crystal molecules may be controlled. When the first and second oxide alignment layers 410 and 420 are formed through a plasma thin-film forming process using an inorganic target, the inorganic target and the substrate should be parallel with each other to form the first and second oxide alignment layers 410 and 420 to a uniform thickness.

Each of the first and second oxide alignment layers. 410 and 420 may have, for example, a thickness of about 500 Å to about 3,000 Å, so that a pretilt angle of liquid crystal molecules may be easily controlled in each portion of the first and second oxide alignment layers 410 and 420. Moreover, the LCD device may be driven without increasing a driving voltage, so that power consumption of the LCD device need not be increased.

Hereinafter, a method of manufacturing the second display substrate will be described in detail with reference to FIGS. 1 to 3.

In order to manufacture the second display substrate 200, the black matrix 210 is formed on the second insulation substrate 201, and then the color filter 230 is formed on the second insulation substrate 201 and the black matrix 210.

Then, the overcoat layer 240 is formed on the color filter 230, and then the common electrode 250 is formed on the entire surface of the overcoat layer 240. Alternatively, the common electrode 250 may be directly formed on the color filter 230 without the formation of the overcoat layer 250.

Then, the cell gap maintaining part (spacers) 280 and the shaped organic layer 260 are formed on the common electrode 250.

Then, the second oxide alignment layer 420 is formed on the shaped organic layer 260. As described above, the second alignment layer 420 may be formed by using, for example, a chemical vapor deposition such as a PECVD process, a sputtering process, an evaporation process, a CVD process, or other process.

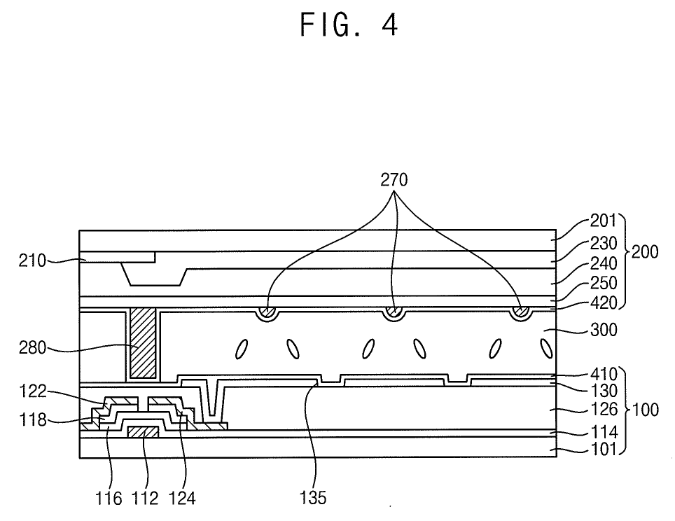

FIG. 4 is a cross-sectional view of an LCD device according to another exemplary embodiment of the present invention. In FIG. 4, the LCD device is substantially the same as the LCD device of FIG. 2 except for instead of having the shaped organic layer, a plurality of protrusions 270 are formed in each pixel area. Thus, the same reference numerals will be used to refer to the same or like parts as those described in FIG. 2 and any further explanation concerning the common elements will be omitted.

Referring to FIG. 4, protrusions 270, instead of the shaped organic layer, are formed on the common electrode 250 of the second display substrate 200. The protrusions 270 may be arranged so as to not overlap with an opening portion 135. The protrusions 270 and the opening portions 135 change the direction of the electric field across the liquid crystal layer 300. The arrangement of the liquid crystal molecules in the liquid crystal layer 300 is changed at a boundary portion between the protrusion 270 and the opening portion 135, so that a multi-domain is generated in each pixel. Moreover, the viewing angle of the multi-domain liquid crystal display is increased as the multi-domain is generated.

Alternatively, a second oxide alignment layer 420 is continuously formed on the protrusions 270 to control liquid crystal alignment, in substantially the same way as that of the shaped organic layer.

According to another exemplary embodiment of the present invention, the LCD device may include a metal oxide layer interposed between the liquid crystal layer when a protrusion is formed on one of the electric field generating electrodes of the first and second display substrates in order to enhance liquid crystal alignment and response speed. For example, when a color filter is formed on the second display substrate, the first display substrate facing the second substrate may include a patterned transparent electrode, and the second display substrate may include a transparent electrode, a cell gap spacer and a protrusion. Here, the cell gap spacer may be a column-shaped spacer defines the gap between the first display substrate and the second display substrate. The column spacer may include the same material as that of the protrusion. For example, the material used for the mountain-shaped structure or the protrusion structure may include a photosensitive organic material the characteristics of which are changed when light is applied thereto, and the photosensitive organic material may include a photoacid generator.

Generally, the LCD device may include a first display substrate having a TFT formed thereon, and a second display substrate having a color filter formed thereon. Alternatively, the LCD device may include a first display substrate having a TFT and a color filter formed thereon, and a second display substrate facing the first display substrate. Here, an unpatterned transparent electrode may be applied to the display substrate having the mountain-shaped organic layer or the protrusion structure. Therefore, even though a patterning process corresponding to a transparent electrode is not additionally performed, a sufficient alignment effect may be obtained.

The oxide alignment layer may include silicon oxide (SiOx) such as SiO2 and SiO, magnesium oxide (MgO), titanium oxide (TiO2), etc. In the case of the silicon oxide (SiOx), an alignment of liquid crystal may be controlled in accordance with a range of ‘x’. In a SiO thin film mainly including Si—Si bonds having non-polarity, and a SiO2 thin film mainly including Si—O bonds having superior polarity, a difference in dipole distribution density is generated. Thus, a superior exchange force between dipoles may be increased as the SiO2 having a high oxygen content is introduced. However, when ‘x’ is small, absorption of visible rays is increased in an oxygen process, and thus ‘x’ should be optimized in order to enhance transmittance. According to the above alignment principles, when the composition of ‘x’ is small, visible ray absorption is increased in an oxygen process, and thus the composition of ‘x’ should be optimized. Due to the alignment principles, the geometric structure of the substrate surface may be less affected compared to an alignment layer of polyimide (PI) using a chain alkyl series.

According to exemplary embodiments of the invention described above, a “mountain”-shaped structure or a protrusion structure is formed using a photosensitive organic material, and an oxide is used as an alignment-inducing layer. Here, when the oxide material, for example, silicon oxide, is deposited through changing conditions, such as pressure, temperature, an inclination angle between a deposition substrate and a deposition source, etc., an alignment effect of a horizontal, a vertical or an inclination direction may be obtained regardless of a surface structure. The alignment of liquid crystal molecules is not affected by the surface morphology of an oxide alignment layer, and the liquid crystal alignment is induced by an interaction force between the alignment layer and liquid crystal molecules, so that an alignment surface treatment process, such as rubbing or ion beam irradiation, may be omitted.

Therefore, defects such as uncoated areas and vertical alignment errors of an alignment layer, which are generated when an inorganic solution is applied, may be prevented.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A display substrate comprising:
an insulation substrate;
a common electrode formed on the insulation substrate;
a cell gap maintaining part formed on the common electrode;
a liquid crystal (LC) alignment support part of an organic material formed on the common electrode; and
an oxide alignment layer formed on the LC alignment support part.

2. The display substrate of claim 1, wherein the LC alignment support part has a plurality of inclined surfaces so as to pretilt a liquid crystal layer.

3. The display substrate of claim 2, wherein the LC alignment support part has a continuous mountain shape of which positively inclined surfaces and negatively inclined surfaces alternate.

4. The display substrate of claim 1, further comprising a color filter formed on the insulation substrate, wherein the common electrode is formed on a whole surface of the color filter.

5. The display substrate of claim 1, wherein the LC alignment support part has discontinuous protrusions so as to pretilt a liquid crystal layer.

6. The display substrate of claim 1, wherein the oxide alignment layer includes at least one selected from the group consisting of silicon oxide (SiOx), titanium oxide (TiO2) and magnesium oxide (MgO).

7. The display substrate of claim 1, wherein the LC alignment support part is formed from the same material as that of the cell gap maintaining part.

8. A liquid crystal display (LCD) device comprising:
a first display substrate including a pixel electrode formed on a first insulation substrate;
a second display substrate facing the first display substrate, the second display substrate comprising:
a second insulation substrate;
a common electrode formed on the entire surface of the second insulation substrate;
a cell gap maintaining part formed on the common electrode;
a liquid crystal (LC) alignment support part of an organic material formed on the common electrode; and
an oxide alignment layer formed on the LC alignment support part; and
a liquid crystal layer interposed between the first display substrate and the second display substrate.

9. The LCD device of claim 8, wherein the LC alignment support part has a plurality of inclined surfaces so as to pretilt the liquid crystal layer.

10. The LCD device of claim 8, wherein the LC alignment support part has a mountain shape of which positively inclined surfaces and negatively inclined surfaces alternate.

11. The LCD device of claim 8, wherein the LC alignment support part has a plurality of discontinuous protrusions.

12. The LC of claim 8, wherein the oxide alignment layer includes at least one selected from the group consisting of silicon oxide (SiOx), titanium oxide (TiO2) and magnesium oxide (MgO).

13. A liquid crystal display (LCD) device comprising:
a first display substrate including a first electrode formed on a first insulation substrate;
a second display substrate facing the first display substrate, the second display substrate comprising a second electrode formed on a second insulation substrate;
a liquid crystal layer formed between the first display substrate and the second display substrate;
a cell gap maintaining part positioned between the first display substrate and the second display substrate to maintain a predetermined distance between the first and second display substrates;
a liquid crystal (LC) alignment support part formed on the second electrode, the LC alignment support part having a plurality of inclined surfaces so as to pretilt a liquid crystal layer; and
an oxide alignment layer formed on the LC alignment support part.

14. The LCD device of claim 13, wherein the second electrode is formed on the entire display area of the second insulation substrate.

15. The LCD device of claim 13, wherein the LC alignment support part has a mountain shape of which positively inclined surfaces and negatively inclined surfaces alternate.

16. The LCD device of claim 13, wherein LC alignment support part has a plurality of discontinuous protrusions configured to pretilt the liquid crystal layer.

17. The LCD device of claim 13, wherein the oxide alignment layer includes at least one selected from the group consisting of silicon oxide (SiOx), titanium oxide (TiO2) and magnesium oxide (MgO).
